(19) United States
(12) Patent Application Publication
(10) Pub. No.: US 2002/0120037 A1
(43) Pub. Date: Aug. 29, 2002

(54) Non-wax drip closure sealant and shell

(76) Inventors: Homaira Naseem, Boylston, MA (US); John V. Skilton, Bremen (DE)

Correspondence Address: Robert W. Fieseler, McAndrews, Held & Malloy, Ltd., 34th Floor, 500 West Madison Street, Chicago, IL, 60661, US

(21) Appl. No.: 10/000,857

(22) Filed: Nov. 2, 2001

Related U.S. Application Data
(60) Provisional application No. 60/245,399, filed on Nov. 2, 2000.

(51) Int. Cl. C08L 3/02

(52) U.S. Cl. 524/48; 524/230; 524/237

(57) ABSTRACT

A closure sealant composition is suitable for sealing a lid to a container. The closure sealant composition comprises (a) a resin constituent selected from the group consisting of a polymeric resin and a blend of polymeric resins; and (b) at least one additive constituent selected from the group consisting of behenamide, a cyclodextrine and a plurality of cyclodextrines. The closure sealant composition preferably comprises 0.5 wt % to 5 wt % behenamide. The closure sealant composition can also comprise glycerol monostearate. The resin can comprise polyolefin, such as metallocene or ethylene vinyl acetate, as well as rubber.

### CROSS-REFERENCE TO RELATED APPLICATIONS(S)

The present application relates to and claims priority benefits from U.S. Provisional Patent Application Serial No. 60/245,399 filed Nov. 2, 2000, entitled “Non-Wax Drip Closure Sealant and Shell”, which is incorporated by reference in its entirety.

### FIELD OF THE INVENTION

The present invention relates to materials used to seal lids to containers. More particularly, the present invention relates to lubricants for use in closure sealants for lids of food and beverage containers.

### BACKGROUND OF THE INVENTION

Beverages and food are often stored in a container, such as a jar or a bottle, covered by a lid. The term lid is used broadly herein to include closure mechanisms such as caps. The lid can be removably engaged to the container. Typically, the lid and a top portion of the container have threads to permit threadable engagement. In order to seal the lid to the container when the lid has been twisted onto the container, a closure sealant or liner is often employed. The closure sealant is positioned on an interior surface of the lid and/or on the mouth of the container to provide a seal between the lid and the mouth of the container. Two of the functions that can be performed by the closure sealant are: (a) preventing contaminants from entering the container from outside of the container, and (b) preventing food or beverage components, such as carbonation, from exiting the container.

When the lid is tightly engaged to the container, the container's mouth penetrates into the closure sealant, causing the closure sealant to be under a lot of compression. In order for consumers to be able to twist the lid off of the container, a lubricant is often desirable to facilitate the sliding of the lid along the mouth of the container. The lubricant reduces the removal torque.

In order to provide adequate lubrication, the lubricant should migrate to the surface of the closure sealant. The lubricant comes into contact with the mouth of the container or with the lid, whichever is not coated with closure sealant. If both the lid and mouth are coated with closure sealant, then the lubricant from the mouth comes into contact with the lubricant from the lid. Following migration, at the surface of the closure sealant, the lubricant changes from amorphous to either a semi-crystalline or a crystalline state.

The migration of the lubricant forms bloom on the surface of the closure sealant. Without bloom or with very little bloom, lubrication will generally not be satisfactory. On the other hand, too much bloom causes wax fall (also known as wax flakes or wax drops) to form on the surface of the sealant. Wax fall is due to lack of sufficient adhesion to remain attached to the surface of the closure sealant. Thus, wax which has a crystalline, sugary appearance, tends to fall into the drink or food held in the container. The wax fall has an appearance that is unappealing to consumers, especially if the wax fall is strikingly different in color than the food or drink into which it has fallen. Another problem is that the wax fall can spoil the food or beverage in the container by altering the flavor. For example, while a consumer drinks soda from a bottle that has wax fall on the bottle mouth, soda contacts the wax fall while passing over the bottle's mouth. Conventional closure sealant lubricants such as erucamide, oleamide, and stearates, tend to have excess bloom that forms wax on the closure sealant surface. Thus, there is a need for a closure sealant that produces less wax bloom.

Wax bloom can be a significant problem if the closure sealant is exposed to high temperature conditions. Heat drives the lubricant to the surface of the closure sealant, causing a lot of bloom. Temperatures of about 65 degrees Celsius inside of a delivery truck are not uncommon and expose food and beverage containers to high temperatures. High temperatures are also common in warehouses. Thus, there is a need for a closure sealant that produces less wax bloom under high temperature conditions.

Conventional closure sealants for beverage or food containers have utilized lubricants such as erucamide, oleamide, and stearates, each of which is conjugated. Because those lubricants are conjugated, erucamide, oleamide, and stearates are susceptible to photochemical breakdown and oxidative breakdown. For example, oxidative breakdown of erucamide, by ozone sterilization, can create flavor-detracting contaminants such as aldehydes and/or ketones. Ozone sterilization is frequently performed to sterilize bottled water products, such as mineral water and spring water. The United States Food and Drug Administration requires ozone sterilization for sterilizing bottled water products manufactured and sold in the United States. Thus, there is a need for a closure sealant lubricant that is resistant to oxidative breakdown from ozone sterilization. Additionally, there is a need for a closure sealant lubricant that is resistant to photochemical breakdown.

### SUMMARY OF THE INVENTION

In one embodiment of the present closure sealant composition for sealing a lid to a container, the closure sealant composition comprises (a) a resin constituent selected from the group consisting of a polymeric resin and a blend of polymeric resins; and (b) at least one additive constituent selected from the group consisting of behenamide, a cyclodextrine and a plurality of cyclodextrines.

In a preferred embodiment, the additive constituent comprises behenamide in an amount that is 0.5 wt % to 5 wt % of the sealant composition. In a more preferred embodiment, the additive constituent comprises behenamide in an amount that is 1 to 3 wt % of the sealant composition. In a further preferred embodiment, the additive constituent comprises behenamide in an amount that is 1.75 to 2.5 wt % of the sealant composition. The closure sealant composition can also comprise glycerol monostearate. The additive constituent can comprise cyclodextrine in an amount that is 0.3-5 wt %, preferably 0.5-3 wt %, of the closure sealant composition.

The resin or resin blend can comprise a polyolefin and/or a metallocene polyolefin such as LDPE, HDPE, or polypropylene. The resin or resin blend can comprise ethylene vinyl acetate (EVA). A resin blend can comprise a combination of polyolefins. The resin or resin blend can also comprise rubber. The closure sealant composition can further comprise one or more of a colorant, a stabilizer and an oil-based additive (such as a plasticizer).

A method of producing a closure sealant for sealing a lid to a container comprises the steps of (a) mixing a resin with behenamide to form a closure sealant composition and (b) forming pellets of the closure sealant composition.

### BRIEF DESCRIPTION OF THE DRAWINGS

FIGS. 1A and 1B together constitute a table of closure sealant compositions and weight losses for those compositions.

FIG. 2 is a chart of removal torques for three different closure sealant compositions.

FIGS. 3A-3B show the results of one-day tests for torque at ambient temperature for various closure sealant compositions.

FIGS. 4A-4B show the results of one-day tests for torque at cold temperatures for various closure sealant compositions.

### DETAILED DESCRIPTION OF PREFERRED EMBODIMENT(S)

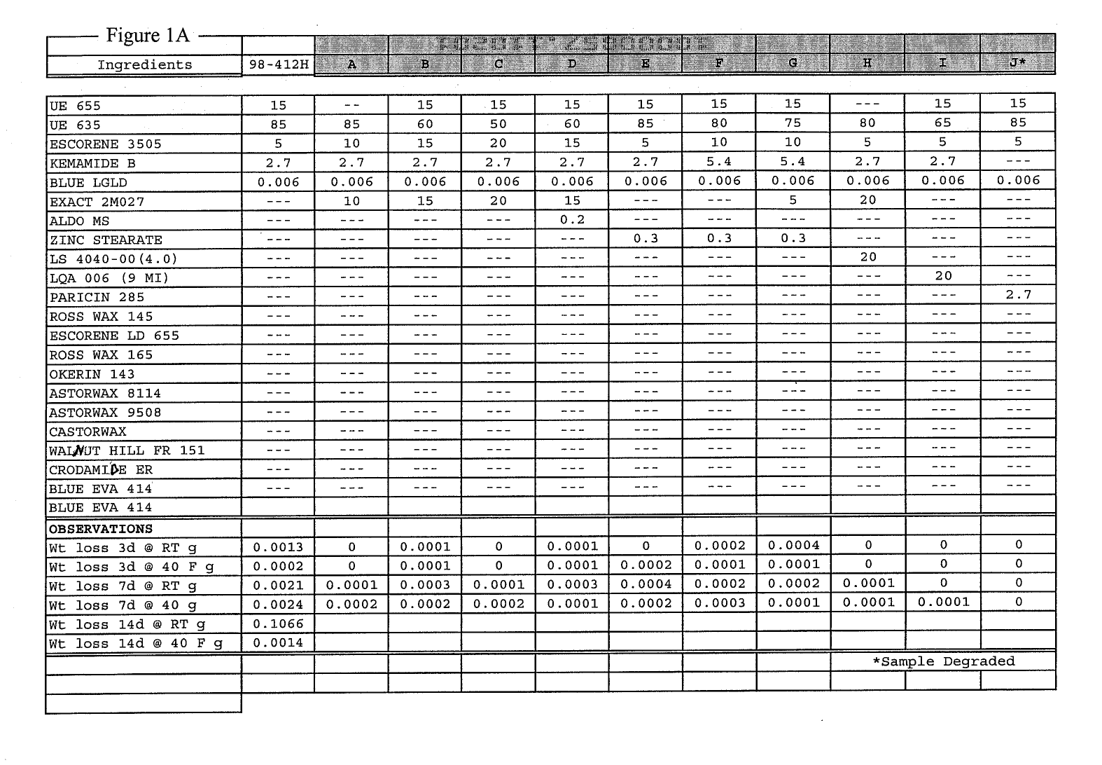

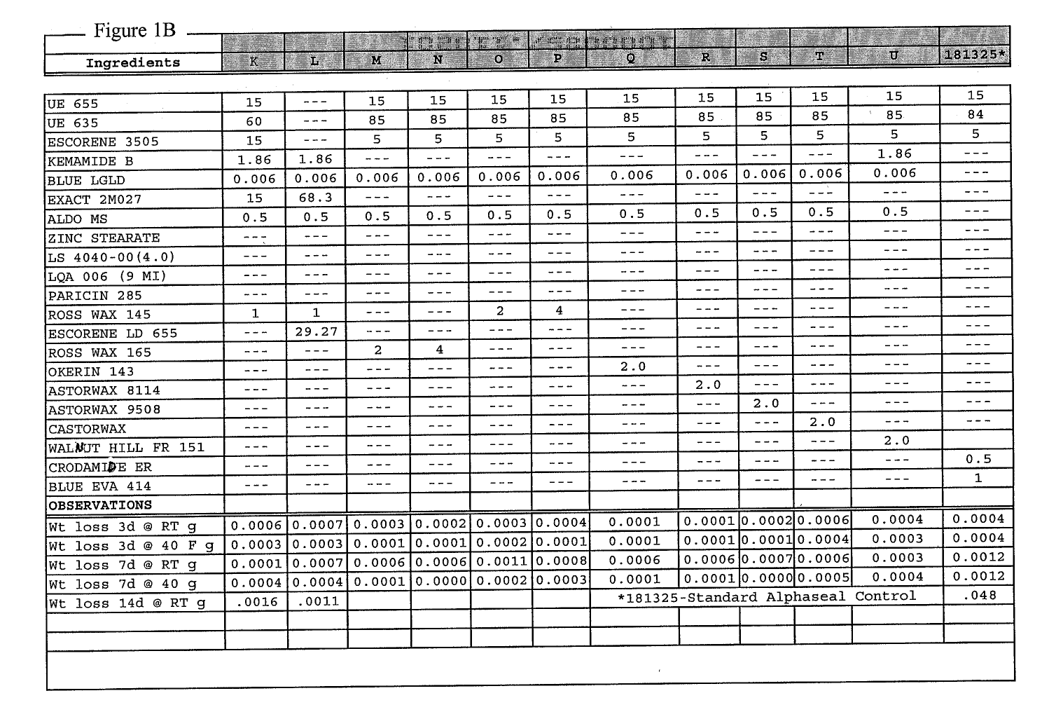

FIGS. 1A and 1B together show weight losses of various compositions tested for suitability as closure sealants. Composition 98-412H and compositions A through I all contained behenamide as a lubricant. The behenamide was KEMAMIDE B supplied by Witco. Compositions J through 181325 contained other lubricants, either in combination with behenamide, alone, or in combination with lubricants other than behenamide.

Each of the samples in FIGS. 1A and 1B, as well as the other samples discussed below, were prepared in the following manner. The ingredients were dry blended in a ribbon blender. The dry blend was mixed in a Farrell continuous mixer. Other mixers, such as twin and single screw mixers are suitable. The mixed material exited the Farrell continuous mixer into a single screw machine that pumped the mixed material out through a die. The material exited the die underwater in a molten state and was cut and pelletized. The pellets were then molded into shapes suitable for testing the properties of closure sealants.

Table 1 below is a portion of FIGS. 1A and 1B showing the compositions and weight losses of 98-412H and 181325. Composition 181325 was a standard ALPHASEAL composition which comprised CRODAMIDE erucamide, supplied by Croda Universal, as a lubricant. Composition 181325 was considered the control composition because similar compositions are used in industry as closure sealants. The 98-412H composition included 2.5 wt % behenamide (2.7 is shown in Table 1 and in FIG. 1A because Table 1 and FIG. 1A show the amount of lubricant as a percentage of the overall resin weight) and 4.64 wt % polypropylene (Escorene 3505). 98-412H also included 15 parts UE 655 and 85 parts UE 635. UE 655 and UE 635 are EVA manufactured by Equistar. The weight losses of the 98-412H sample having behenamide as a lubricant were greater in four of the five tested categories compared to the weight losses of the 181325 control sample. The weight losses of 98-412H increased with duration more quickly than the weight losses of 181325.

TABLE 1
Compositions and Weight Loss

| Ingredients | 98-412H | 181325* |
|---|---|---|
| UE 655 | 15 | 15 |
| UE 635 | 85 | 84 |
| ESCORENE 3505 | 5 | 5 |
| KEMAMIDE B | 2.7 | — |
| BLUE LGLD | 0.006 | — |
| CRODAMIDE ER | — | 0.5 |
| BLUE EVA 414 | — | 1 |

Observations

| | | |
|---|---|---|
| Wt loss 3d @ RT g | 0.0013 | 0.0004 |
| Wt loss 3d @ 40 F g | 0.0002 | 0.0004 |
| Wt loss 7d @ RT g | 0.0021 | 0.0012 |
| Wt loss 7d @ 40 F g | 0.0024 | 0.0012 |
| Wt loss l4d @ RT g | 0.1066 | 0.048 |
| Wt loss l4d @ 40 F g | 0.0014 | — |

*Control samples

Columns J-U of FIGS. 1A and 1B display compositions that comprise a wax other than behenamide or comprise a combination of waxes (some of the combinations include behenamide). The compositions in columns J-U did not have superior weight loss results compared to either the 98-412H composition or the 181325 composition.

Closure sealants with a Shore A hardness of 95 or less are preferred in some applications because the sealant will be suitably flexible. The hardness of the 98-412H composition after 24 hours was 97/93, where 97 is the instant reading and 93 is the reading after a 15 second delay. The hardness of the 98-412H composition after 24 hours was the same as the hardness of the 181325 control sample. Samples A, B, H, and I had hardnesses exceeding 95, which can be undesirable for some applications. Samples J-U were not tested for hardness.

Table 2 below compares the dynamic coefficient of friction test of five compositions tested against a PET (polyethylene) surface. The control composition in Table 2 was the 181325 composition of FIG. 1b except that the 181325 composition in Table 2 had 0.4 wt % erucamide and the remainder EVA (ethylene vinyl acetate). The four other compositions in Table 2 had some behenamide. The coefficients of friction in the four samples containing behenamide were generally greater than the coefficients of friction of the control composition. The coefficients of the behenamide samples were within desired ranges for closure sealants, however. In addition, the coefficients of friction of the behenamide-containing samples tended to decrease from 7 days to 14 days, and became closer to the coefficient of friction of the control sample from 7 days to 14 days.

TABLE 2
Dynamic Co-efficient of Friction Test Against PET

| | | Level | | | | | | | | |
|---|---|---|---|---|---|---|---|---|---|---|
| | | (wt %)/ | 7 Day | | 14 Day | | 7 Day | | 14 Day | |
| | Resin/ | Thickness | Ambient | | Ambient | | @ 4.4° C. | | @ 4.4° C. | |
| Sample | Additive | (mils) | x¹ | s² | x¹ | s² | x¹ | s² | x¹ | s² |
| 181325* | EVA/ | 0.4 | 0.19 | 0.01 | 0.24 | 0.03 | 0.25 | 0.01 | 0.35 | 0.02 |
| | ERU | 30 | | | | | | | | |
| 98-412B | EVA/ | 1.8 | 0.36 | 0.01 | 0.33 | 0.02 | 0.33 | 0.02 | 0.32 | 0.02 |
| | BEH | 30 | | | | | | | | |
| 98-412D | METALL | 1.86 | 0.36 | 0.04 | 0.35 | 0.01 | 0.33 | 0.01 | 0.30 | 0.00 |
| | PE/ | 30 | | | | | | | | |
| | BEH | | | | | | | | | |
| 98-412H | EVA/ | 2.5 | 0.40 | 0.06 | 0.39 | 0.05 | 0.37 | 0.03 | 0.39 | 0.10 |
| | BEH | 30 | | | | | | | | |
| 98-412I | EVA/ | 2.5 | 0.36 | 0.05 | 0.33 | 0.03 | 0.33 | 0.02 | 0.33 | 0.04 |
| | BEH | 30 | | | | | | | | |

*Control
¹All means based upon four samples.
²All standard deviations based upon four samples.

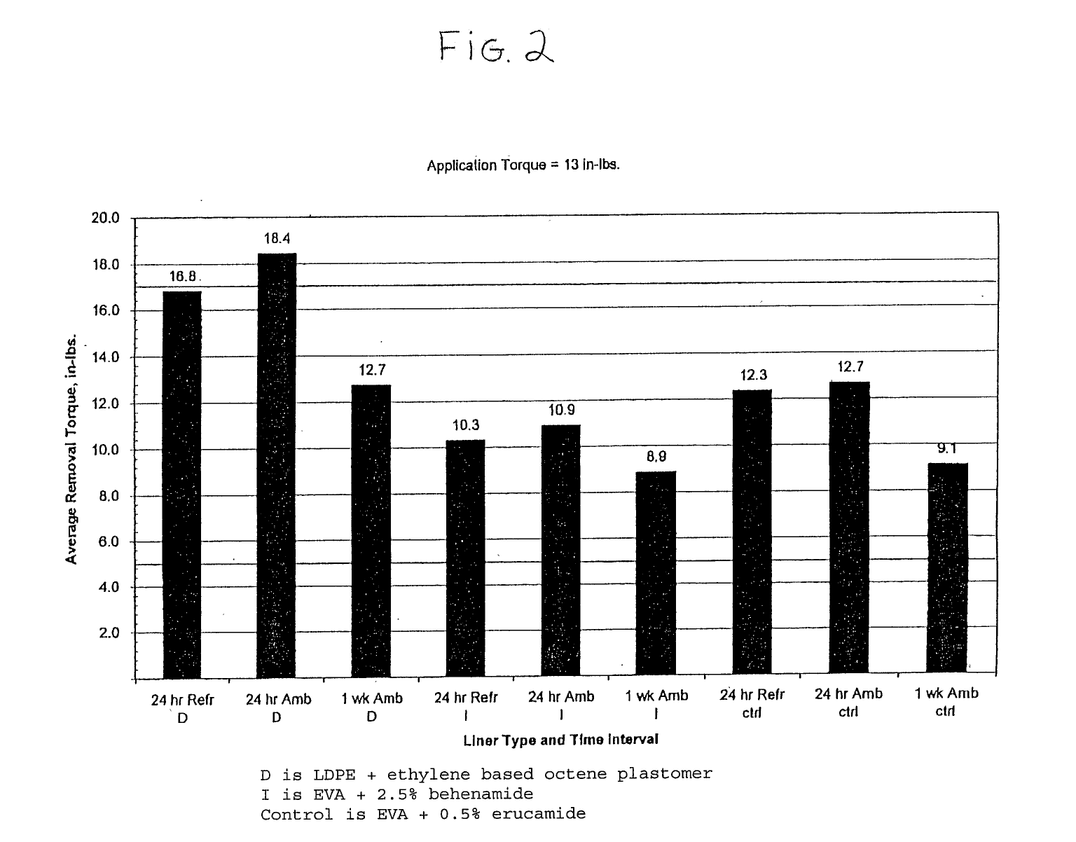

FIG. 2 is a chart showing the removal torque for three different closure sealants. Removal torque was tested for each of the three closure sealants under three different circumstances: 24 hours of refrigeration at 40 degrees Fahrenheit (4.4 degrees Celsius), 24 hours in ambient temperature, and 1 week at ambient temperature. The closure sealant labeled D in FIG. 2 comprised low-density polyethylene (LDPE) and ethylene-based octene plastomer. The closure sealant labeled I comprised EVA and 2.5 wt % behenamide. The control composition comprised EVA and 0.5 wt % Erucamide. The EVA in closure sealant I was supplied by Exxon, whereas the EVA of sample H was supplied by Equistar. As seen in FIG. 2, under the three testing situations, the closure sealant composition comprising behenamide (labeled I) had the lowest removal torque.

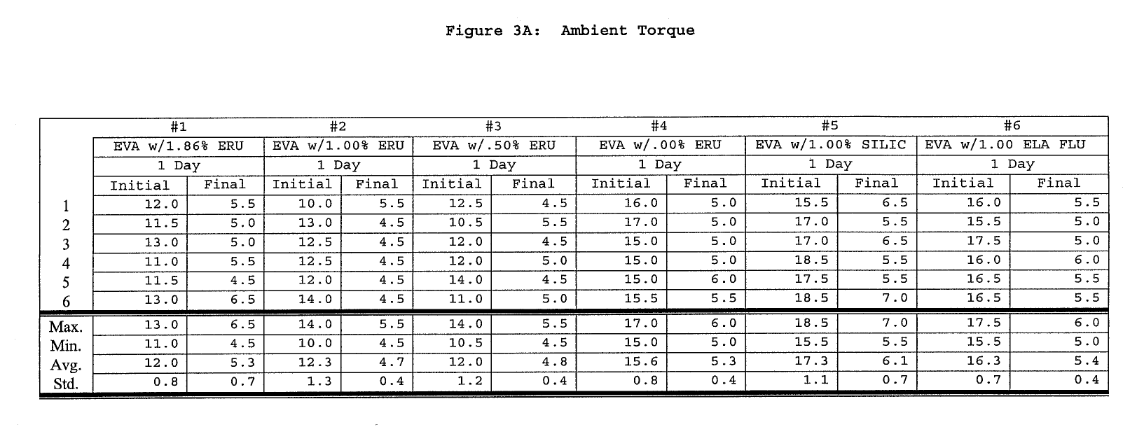

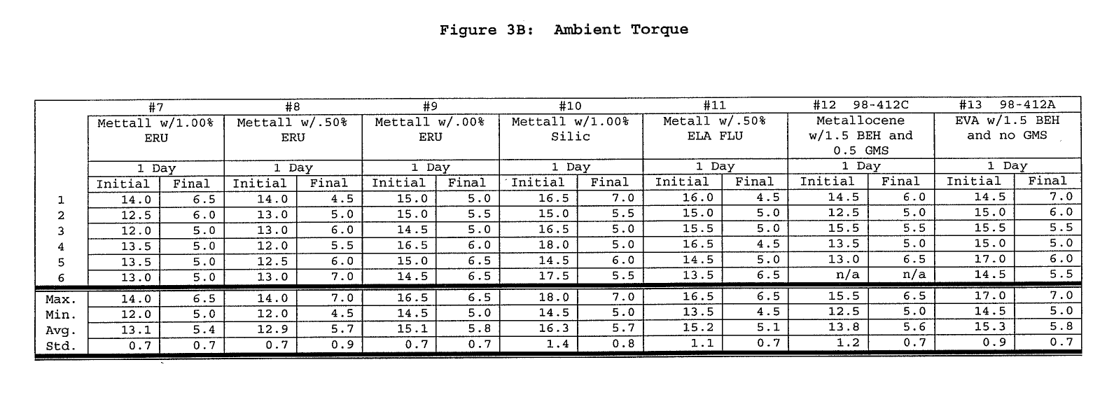

FIGS. 3A and 3B show the results of one day tests for torque at ambient temperature of various closure sealant compositions. The tests were performed initially (when the seal is first broken) and finally (as the cap is coming off of the bottle). Generally, torques of between 8 and 18 in-lbs are acceptable in the beverage industry. Table 3 below shows a portion of FIGS. 3A and 3B. As shown in Table 3, the two closure sealant compositions comprising behenamide had torques that were similar to the torque of the control composition comprising EVA with 0.5 wt % ERU. In Table 3, the composition with 0.5 wt % eru is considered to be the control sample because that composition is commonly used in industry. The average initial and final torques for the composition with 0.5% ERU were 12.0 and 4.8, respectively. The average initial and final torques for the composition with 1.5 wt % behenamide and 0.5 wt % GMS were 13.8 and 5.6, respectively. The average initial and final torques for the composition with 1.5 wt % behenamide and no GMS were 15.3 and 5.8, respectively. GMS with behenamide appeared to improve the torque results compared to the sample comprising behenamide with no GMS. Although no torque test was performed on a composition comprising GMS, EVA, and behenamide, such a composition can be suitable as a closure sealant.

TABLE 3

| | #3 | | #12 98-412C | | #13 98-412A | |
|---|---|---|---|---|---|---|
| | EVA | | Metallocene w/1.5 | | EVA w/1.5 BEH | |
| | w/.50% ERU | | BEH and 0.5 GMS | | and no GMS | |
| | 1 Day | | 1 Day | | 1 Day | |
| | Initial | Final | Initial | Final | Initial | Final |
| 1 | 12.5 | 4.5 | 14.5 | 6.0 | 14.5 | 7.0 |
| 2 | 10.5 | 5.5 | 12.5 | 5.0 | 15.0 | 6.0 |
| 3 | 12.0 | 4.5 | 15.5 | 5.5 | 15.5 | 5.5 |
| 4 | 12.0 | 5.0 | 13.5 | 5.0 | 15.0 | 5.0 |
| 5 | 14.0 | 4.5 | 13.0 | 6.5 | 17.0 | 6.0 |
| 6 | 11.0 | 5.0 | n/a | n/a | 14.5 | 5.5 |
| Max. | 14.0 | 5.5 | 15.5 | 6.5 | 17.0 | 7.0 |
| Min. | 10.5 | 4.5 | 12.5 | 5.0 | 14.5 | 5.0 |
| Avg. | 12.0 | 4.8 | 13.8 | 5.6 | 15.3 | 5.8 |
| Std. | 1.2 | 0.4 | 1.2 | 0.7 | 0.9 | 0.7 |

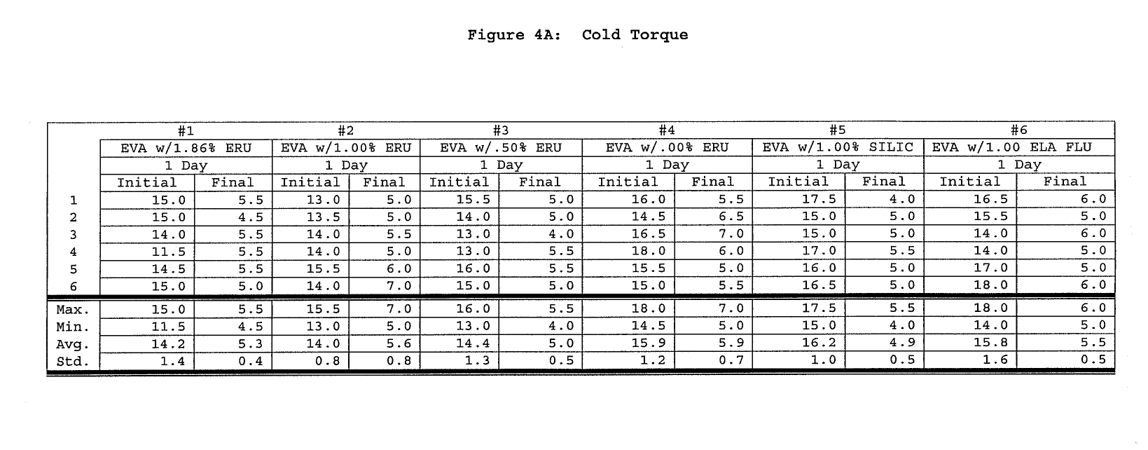

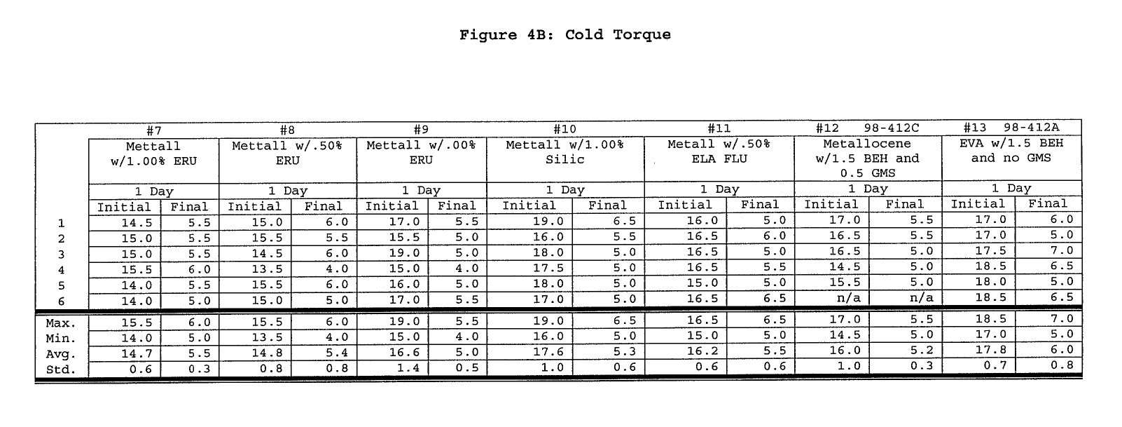

FIGS. 4A and 4B show the results of one day tests for torque at a cold temperature (refrigerated at 40 F.) of various closure sealant compositions. The tests were performed initially and finally. Table 4 below shows a portion of FIGS. 4A and 4B. As seen in Table 4, the two closure sealant compositions comprising behenamide had torques that were similar to the torque of the control composition comprising EVA with 0.5 wt % ERU. In Table 4, the composition with 0.5 wt % ERU is considered to be the control sample because that composition is commonly used in industry. The average initial and final torques for the composition with 0.5% ERU were 14.4 and 5.0, respectively. The average initial and final torques for the composition with 1.5 wt % behenamide and 0.5 wt % GMS were 16.0 and 5.2, respectively. The average initial and final torques for the composition with 1.5 wt % behenamide and no GMS were 17.8 and 6.0, respectively. GMS with behenamide appeared to improve the torque results compared to the sample comprising behenamide with no GMS. GMS (glycerol monostearate) can be included in the closure sealant as a processing aid with some slip characteristics. A fluoroelastomer can additionally or alternatively be included in the closure sealant as a processing aid having some slip characteristics.

TABLE 4
Cold Torque

| | | | #12 98-412C | | | |
|---|---|---|---|---|---|---|
| | #3 | | Metallocene | | #13 98-412A | |
| | EVA w/.50% | | w/1.5 BEH and | | EVA w/1.5 BEH | |
| | ERU | | 0.5 GMS | | and no GMS | |
| | 1 Day | | 1 Day | | 1 Day | |
| | Initial | Final | Initial | Final | Initial | Final |
| 1 | 15.5 | 5.0 | 17.0 | 5.5 | 17.0 | 6.0 |
| 2 | 14.0 | 5.0 | 16.5 | 5.5 | 17.0 | 5.0 |
| 3 | 13.0 | 4.0 | 16.5 | 5.0 | 17.5 | 7.0 |
| 4 | 13.0 | 5.5 | 14.5 | 5.0 | 18.5 | 6.5 |
| 5 | 16.0 | 5.5 | 15.5 | 5.0 | 18.0 | 5.0 |
| 6 | 15.0 | 5.0 | n/a | n/a | 18.5 | 6.5 |
| Max. | 16.0 | 5.5 | 17.0 | 5.5 | 18.5 | 7.0 |
| Min. | 13.0 | 4.0 | 14.5 | 5.0 | 17.0 | 5.0 |
| Avg. | 14.4 | 5.0 | 16.0 | 5.2 | 17.8 | 6.0 |
| Std. | 1.3 | 0.5 | 1.0 | 0.3 | 0.7 | 0.8 |

Behenamide is fully saturated and is therefore believed to be relatively resistant to ozone oxidation and to photochemical oxidation. Behenamide has a neutral taste and odor compared to erucamide.

Resins suitable for use with closure sealants in accordance with some embodiments of the present composition can include polyolefin resins and blends thereof. Polyolefin resins include LDPE, HDPE, EVA and polypropylene, as well as metallocene polyolefins. Resins suitable for use with closure sealants in accordance with some embodiments of the present composition can include elastomer resins and blends thereof. Resins can include one or more polyolefin resins blended with one or more elastomer resins. Suitable elastomer resins include but are not limited to SBS (styrene butadiene styrene), SEBS (styrene ethylene butadiene styrene), EPDM (ethylene propylene diene monomer), SIS (styrene isoprene styrene). Butyl rubber is a suitable elastomer and is a copolymer of isobutylene and isoprene. The resin can comprise rubber that has been vulcanized and/or rubber that has not been vulcanized. Rubber facilitates compression of the closure sealant.

In addition to resin and behenamide, a closure sealant can include one or more of the following additives: a pigment, a filler, a plasticizer and/or a stabilizer. Oil can be added as a plasticizer, and the closure sealant can have mineral oil that is paraffinic oil or naphthenic.

Cyclodextrines can reduce or eliminate a wide variety of off-flavor chemicals. Cyclodextrines can be included in the closure sealant to remove or stop off-flavors that can form in the closure sealant, or the cyclodextrine can hinder or stop off-flavors that could otherwise enter the container from outside of the container. Examples of off-flavors include trichloranisols, dichlorphenols, and naphthalene (mothballs).

Table 5 below shows compositions of three resin formulas.

TABLE 5
Resin Composition

| | | |
|---|---|---|
| Formula 1 | SBS resin D 1102 | 42% |
| | PE Escorene 605 | 48% |
| | Paraffin oil | 10% |
| Formula 2 | EVA 9% (DuPont 650) | 95% |
| | SBS 1102 | 5% |
| Formula 3 | Butyl Rubber 301 (Bayer) | 25% |
| | HDPE 20 melt | 75% |

Table 6 shows different amounts of cyclodextrine that were added to each of the three resin formulas shown in Table 5. Table 6 also shows the amount of three off-flavors (trichloranisols (TCA), dichlorphenols (DCP), and naphthalenes (Naph)) that were detected in the head space of the test containers. The amounts of contamination are in units of nanograms. Ring diameters of the cyclodextrines were 13.7 Ang, 16.3 Ang and 16.9 Ang. The cyclodextrines were supplied by Wacker Chemie of Germany.

TABLE 6
Amount of Off-Flavor in Head Space

| | | | | | | | |
|---|---|---|---|---|---|---|---|
| % cyclodextrine | 0.0 | 0.3 | 0.5 | 0.75 | 1.00 | 2.00 | 3.00 |

Formula 1

| | | | | | | | |
|---|---|---|---|---|---|---|---|
| TCA | 1185 | 1075 | 996 | 722 | 584 | 237 | 196 |
| DCP | 655 | 588 | 533 | 491 | 473 | 369 | 258 |
| Naph | 333 | 270 | 243 | 211 | 168 | 83 | 55 |

Formula 2

| | | | | | | | |
|---|---|---|---|---|---|---|---|
| TCA | 1452 | 1366 | 1191 | 951 | 762 | 467 | 244 |
| DCP | 537 | 463 | 402 | 354 | 277 | 184 | 127 |
| Naph | 258 | 218 | 175 | 143 | 101 | 66 | 35 |

Formula 3

| | | | | | | | |
|---|---|---|---|---|---|---|---|
| TCA | 29 | 23 | 23 | 21 | 18 | 13 | 9 |
| DCP | 58 | 47 | 39 | 33 | 25 | 16 | 10 |
| Naph | 75 | 62 | 55 | 41 | 30 | 19 | 12 |

The tests were performed at 45 degrees Celsius for four weeks in a saturated atmosphere of whichever one of the three off-flavors (TCA, DCP, or Naph) was being tested. A gas chromatograph flame ionization detector was used with head space analysis to determine how much of the off-flavor was in the head space.

The control sample had 0% cyclodextrine. The concentrations of cyclodextrine shown in Table 6 are not wt % but are weight as a percentage of the resin. As seen in Table 6, for all three formulas and for all three off-flavors, the amount of off-flavor in the head space decreased as the concentration of cyclodextrine in the closure sealant formula increased. These tests show that cyclodextrines is effective in hindering or stopping off-flavors from entering a container from outside of the container.

Various closure sealant embodiments in accordance with the present composition can be used with many types of food or beverage containers including, but not limited to: metal, plastic and/or glass containers. The lids or caps can be metal, plastic (typically HDPE or polypropylene) and/or other suitable closure material. The containers can be in the form of bottles, jars or other shapes. Many varying types of beverages can be contained in the container, including carbonated or non-carbonated, alcoholic or non-alcoholic, soy or dairy-based beverages. Other beverages include mineral water, spring water, or table water. Food containers can contain many varying types of foods, including mayonnaise, jam and/or peanut butter.

While particular elements, embodiments and applications of the present invention have been shown and described, it will be understood, of course, that the invention is not limited thereto since modifications can be made by those skilled in the art, particularly in light of the foregoing teachings. It is therefore contemplated by the appended claims to cover such modifications as incorporate those features that come within the scope of the invention.

What is claimed is:

1. A closure sealant composition for sealing a lid to a container, the closure sealant composition comprising:
(a) a resin constituent selected from the group consisting of a polymeric resin and a blend of polymeric resins; and
(b) at least one additive constituent selected from the group consisting of behenamide, a cyclodextrine and a plurality of cyclodextrines.

2. The closure sealant composition of claim 1 wherein the additive constituent comprises behenamide in an amount of 0.5-5 wt % of the closure sealant composition.

3. The closure sealant composition of claim 2 wherein the additive constituent comprises behenamide in an amount of 1-3 wt % of the closure sealant composition.

4. The closure sealant composition of claim 3 further comprising glycerol monostearate.

5. The closure sealant composition of claim 1 wherein the additive constituent comprises cyclodextrine in an amount of 0.3-5 wt % of the closure sealant composition.

6. The closure sealant composition of claim 5 wherein the additive constituent comprises cyclodextrine in an amount of 0.5-3 wt % of the closure sealant composition.

7. The closure sealant composition of claim 3 wherein the additive constituent comprises behenamide in an amount of 1.75-2.5 wt % of the closure sealant composition.

8. The closure sealant composition of claim 1 wherein the resin constituent comprises a polyolefin.

9. The closure sealant composition of claim 8 wherein the resin constituent comprises a metallocene polyolefin.

10. The closure sealant composition of claim 8 wherein the resin constituent comprises ethylene vinyl acetate.

11. The closure sealant composition of claim 1 wherein the resin constituent comprises a rubber.

12. A closure sealant composition for sealing a lid to a container, the closure sealant composition comprising a polymeric resin and 1-3 wt % behenamide.

13. The closure sealant composition of claim 12 wherein the composition comprises 1.75-2.5 wt % behenamide.

14. The closure sealant composition of claim 13 further comprising glycerol monostearate.

15. The closure sealant composition of claim 12 further comprising 0.3-5 wt % cyclodextrine.

16. The closure sealant composition of claim 15 wherein the amount of cyclodextrine is 0.5-3 wt %.

17. The closure sealant composition of claim 12 wherein the polymeric resin comprises a polyolefin.

18. The closure sealant composition of claim 17 wherein the polymeric resin comprises a metallocene polyolefin.

19. The closure sealant composition of claim 17 wherein the polymeric resin comprises ethylene vinyl acetate.

20. The closure sealant composition of claim 12 further comprising an oil-based additive.

21. The closure sealant composition of claim 12 further comprising a colorant.

22. The closure sealant composition of claim 12 further comprising a stabilizer.

23. The closure sealant composition of claim 12 further comprising each of an oil, a colorant and a stabilizer.

24. The closure sealant composition of claim 12 wherein the polymeric resin comprises a rubber.

25. A method of making a closure sealant for sealing a lid to a container, the method comprising the steps of:
(a) mixing a resin with behenamide to form a closure sealant composition; and
(b) forming pellets of the closure sealant composition.
